(19) United States
(12) Patent Application Publication
(10) Pub. No.: US 2006/0263735 A1
(43) Pub. Date: Nov. 23, 2006

(54) Firing setter

(76) Inventors: Tomoo Nagatome, Fukuoka (JP); Tatsuya Sumi, Fukuoka (JP)

Correspondence Address: YOUNG & THOMPSON, 745 SOUTH 23RD STREET, 2ND FLOOR, ARLINGTON, VA, 22202, US

(21) Appl. No.: 10/545,794

(22) PCT Filed: Feb. 12, 2004
(86) PCT No.: PCT/JP04/01492

§ 371 Date: Jun. 20, 2006

(30) Foreign Application Priority Data
Feb. 17, 2003 (JP) 2003-037991

(51) Int. Cl. F27D 5/00

(52) U.S. Cl. 432/258

(57) ABSTRACT

A setter having excellent durability is provided at low cost by including three or more leg portions protruding from an upper surface and a lower surface of the periphery of a flat dish portion made of a fireproof material.

### TECHNICAL FIELD

The present invention relates to a setter capable of holding an electronic component on its upper surface and capable of being stacked in multiple layers in a furnace during firing of an electronic component.

### BACKGROUND ART

In general, in an electronic component production process, a jig known as a ‘setter’ is used during firing of an electronic component. More specifically, the electronic component is disposed on a flat dish portion of the setter, and a plurality of setters are stacked and disposed inside a furnace for firing. FIG. 4 is a schematic view of a known setter wherein FIG. 4(a) is a plan view, FIG. 4(b) is a lateral side view, and FIG. 4(c) is a longitudinal side view.

The setter includes a flat dish portion 1 composed of a flat fireproof material. An electronic component (not shown in the drawing) is disposed on the flat dish portion 1. At the periphery of the flat dish portion 1, leg portions 2 are provided to stabilize the setters when stacked and to prevent the electronic component disposed on the flat dish portion 1 from being damaged. Typically, the leg portions 2 are provided such that they protrude from one side of the flat dish portion 1, as illustrated in FIG. 4. Here, the upper surface is the surface with the leg portions 2 protruding from the flat dish portion 1 (i.e., the surface on the upper side of the lateral side view illustrated in FIG. 4(b)).

When firing, an electronic component is disposed on the flat dish portion 1 of a setter having the leg portions 2. Then, a plurality of such setters is stacked inside a furnace. After firing is completed, the setters are removed from the furnace, and the electronic components are delivered to the next process. The setters are disposed inside the furnace again after new electronic components are disposed. In other words, the setters are used repeatedly and repeatedly undergo thermal expansion and thermal contraction. Due to the load of the electronic component disposed on the setter and reactions with the electronic component, deformation and/or cracks occur.

Conventionally, as illustrated in FIG. 4, the leg portions 2 only use the upper surface of the flat dish portion 1, and the setter including the leg portions 2 that only protrude from the upper surface of the flat dish portion 1. As a result, by repeatedly using the setter, deformation and/or cracks easily occur because only one side of the setter may be degraded since load is applied unidirectionally and only one side of the setter comes into contact with electronic components.

When the setter undergoes deformation and/or cracking or when an electronic component burns onto the upper surface of the flat dish portion 1, the setter must be discarded. Accordingly, a setter having the leg portions 2 protruding only from the upper surface of the flat dish portion 1, as illustrated in FIG. 4, can only be used repeatedly for a relatively small number of times.

To improve the durability of such a setter, technologies such as manufacturing the setter with a material having improved heat-resistance and coating the setter with a material less reactive with the electronic component disposed on the setter have been provided (for example, refer to Japanese Unexamined Patent Application Publication No. 2000-74571). However, since such materials are expensive, the firing cost of an electronic component is increased.

### DISCLOSURE OF INVENTION

The above-described problem can be solved by providing a setter according to embodiments of the present invention, wherein the setter has excellent durability and can be produced at low cost.

A setter according to the present invention is used during firing of an electronic component and includes three or more leg portions protruding from the upper and lower surfaces of the periphery of a flat dish portion, which is constituted of a flat fireproof material. A setter according to a preferable embodiment of the present invention includes protrusions on the upper end faces of the leg portions and depressions that are engageable with the protrusions on the lower end faces of the leg portions.

### BRIEF DESCRIPTION OF THE DRAWINGS

FIG. 1 is a schematic view of a setter according to an embodiment of the present invention. FIG. 1(a) is a plan view; FIG. 1(b) is a lateral side view; and FIG. 1(c) is a longitudinal side view.

FIG. 2 is a schematic view of a setter according to another embodiment of the present invention. FIG. 1(a) is a plan view; FIG. 1(b) is a lateral side view; and FIG. 1(c) is a longitudinal side view.

FIG. 3 is a schematic view of a setter according to another embodiment of the present invention. FIG. 1(a) is a plan view; FIG. 1(b) is a lateral side view; and FIG. 1(c) is a longitudinal side view.

FIG. 4 is a schematic view of a known setter. FIG. 1(a) is a plan view; FIG. 1(b) is a lateral side view; and FIG. 1(c) is a longitudinal side view.

### REFERENCE NUMERALS

1 Flat Dish Portion
2 Leg portions
3 Protrusions
4 Depressions

### Best Mode for Carrying Out the Invention

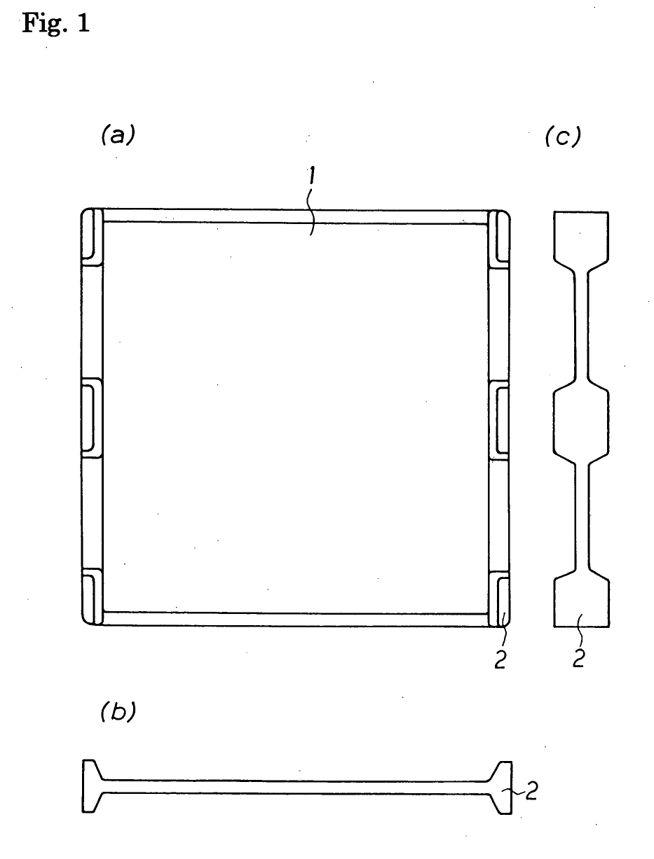

FIG. 1 is a schematic view of a setter according to an embodiment of the present invention, wherein Fig. (a) is a plan view, Fig. (b) is a lateral side view, and Fig. (c) is a longitudinal side view.

The setter includes a flat dish portion 1 made from a flat fireproof material. An electronic component (not shown in the drawing) is disposed on the flat dish portion 1. At the periphery of the flat dish portion 1, leg portions 2 are provided. The leg portions 2 stabilize the setter when the setter is stacked onto other setters and prevent the electronic component from being damaged.

The leg portions 2 of the setter according to the present invention are provided such that they protrude from the upper and lower surfaces of the flat dish portion 1, as illustrated in FIG. 1. Here, the upper surface in the lateral side view of FIG. 1(b) is the upper surface.

When carrying out firing, an electronic component is disposed on the flat dish portion 1 of the setter. Then, the setter is stacked in multiples layers and placed in a furnace. When the setters are stacked in multiples layers, the lower end faces of the leg portions 2 of a setter of an upper layer comes into contact with the upper end faces of the leg portions 2 of a setter of a lower layer. In this way, the setters can be stacked stably.

Three or more leg portions 2 are provided at the periphery of the flat dish portion 1 and more leg portions 2 are provided in the middle depending on the size and weight of the flat dish portion 1. FIG. 1 illustrates a setter having six leg portions 2.

Both the upper and lower surfaces of the flat dish portion 1 of the setter according to the present invention can be used. Therefore, when the setter is repeatedly used, the setter may be turned upside-down so that electronic components can be disposed on the upper and lower surfaces of the flat dish portion 1 alternately when firing. In this way, deformation and cracking of the setter caused by the load of the electronic components and reactions between the electronic components and the setter can be prevented. Accordingly, the durability of the setter can be improved.

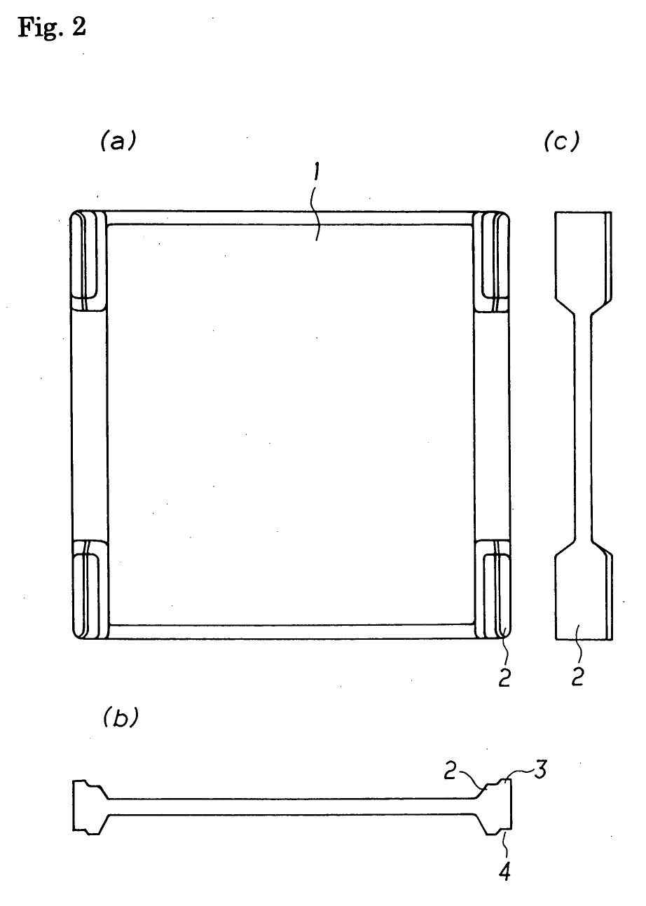

There is a risk that when stacked in multiple layers, the setter illustrated in FIG. 1 might collapse due to displacement. As illustrated in FIG. 2, it is preferable to provide protrusions 3 on the upper end faces of the leg portions 2 and depressions 4, which are engageable with the protrusions 3, on the lower end faces of the leg portions 2. When the setters illustrated in FIG. 2 are stacked in multiple layers, the lower end faces of the leg portions 2 of a setter in an upper layer comes into contact with the upper end faces of the leg portions 2 of a setter in a lower layer. Since the depressions 4 on the leg portions 2 of the upper setter engage with the protrusions 3 on the leg portions 2 of the lower setter, the setters can be stably stacked and displacement can be prevented.

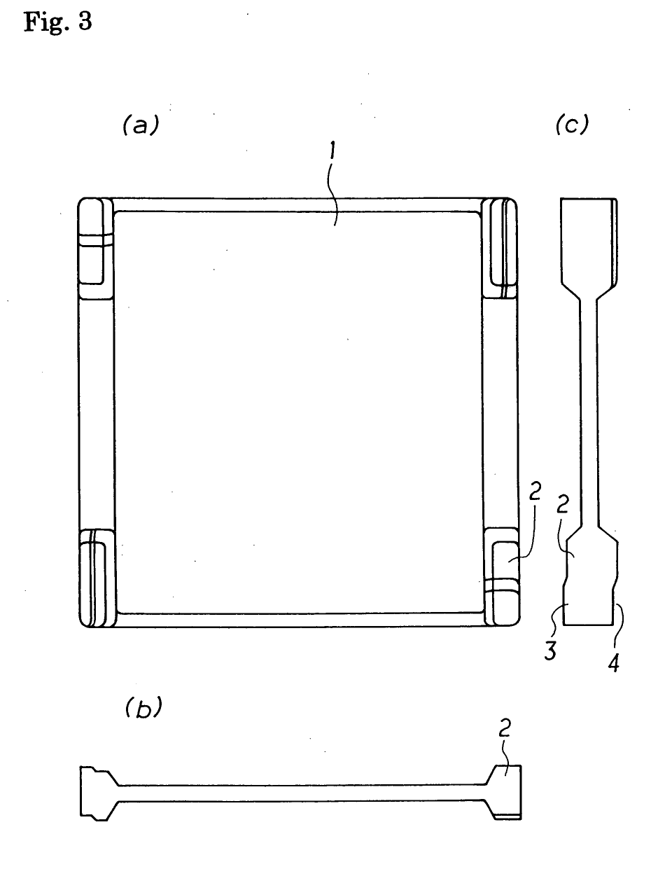

The size and shape of the protrusions 3 and depressions 4 provided on the leg portions 2 are not limited. For example, in addition to those illustrated in FIG. 2, protrusions 3 and depressions 4 illustrated in FIG. 3 may be provided on the leg portions 2.

Accordingly, in the present invention, the material and coating of the setter do not have to be special material and coating. Therefore, a setter having excellent durability can be obtained easily at low cost.

### EXAMPLE

A setter having a shape illustrated in FIG. 3 was used to carry out firing of an electronic component. Firing was carried out with an electronic component disposed on the upper surface of the flat dish portion 1. Then, firing was carried out again after turning the setter upside-down and disposing an electronic component on the lower surface of the flat dish portion 1. In this way, the setter was used repeatedly while disposing electronic components on the upper and lower surfaces of the flat dish portion 1 alternately. This is an example of a setter according to the present invention.

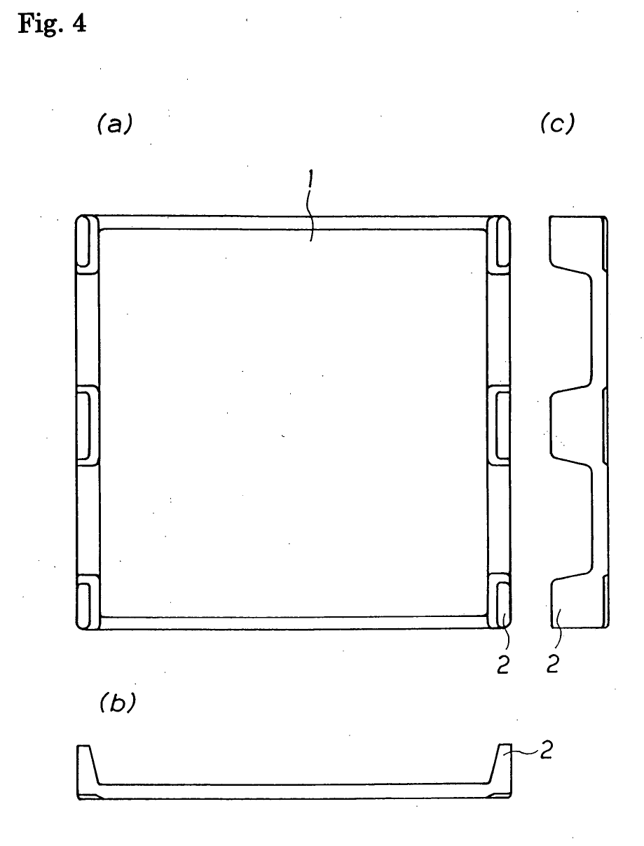

On the other hand, conventionally, a setter having a shape illustrated in FIG. 4 has been used. When using such a setter, electronic components are disposed only on the upper surface of the flat dish portion 1 and the setter is used repeatedly. This is a known example of a setter.

As a result of a study on the durability of the example of a setter according to the present invention and the durability of a setter according to a known example, the setter according to the present invention was usable repeatedly for about 100 times on average, whereas the setter according to a known example was only usable for about 30 times.

### INDUSTRIAL APPLICABILITY

According to the present invention, a setter having excellent durability can be obtained at low cost.

1. A setter used for firing an electronic component, comprising:
leg portions protruding from an upper surface and a lower surface of a flat dish portion made of a flat fireproof material, three or more leg portions being provided at the periphery of the flat dish portion.

2. The setter according to claim 1, wherein protrusions are provided on the upper end surfaces of the leg portions and depressions engageable with the protrusions are provided on the lower end surfaces of the leg portions.
